(19) United States
(12) Patent Application Publication
(10) Pub. No.: US 2023/0276297 A1
(43) Pub. Date: Aug. 31, 2023

(54) TRANSMITTING DATA VIA SIDELINK INTERFACE

(71) Applicant: Lenovo (Singapore) Pte. Ltd., New Tech Park (SG)

(72) Inventors: Prateek Basu Mallick, Dreieich (DE); Joachim Loehr, Wiesbaden (DE); Ravi Kuchibhotla, Chicago, IL (US); Karthikeyan Ganesan, Kronberg im Taunus (DE)

(21) Appl. No.: 18/019,462

(22) PCT Filed: Aug. 5, 2021
(86) PCT No.: PCT/IB2021/057222

§ 371 Date: Feb. 2, 2023

Related U.S. Application Data
(60) Provisional application No. 63/061,715, filed on Aug. 5, 2020.
(60) Provisional application No. 63/061,725, filed on Aug. 5, 2020.
(60) Provisional application No. 63/061,731, filed on Aug. 5, 2020.
(60) Provisional application No. 63/061,734, filed on Aug. 5, 2020.
(60) Provisional application No. 63/061,746, filed on Aug. 5, 2020.

(51) Int. Cl. H04W 28/02; H04L 1/1812

(52) U.S. Cl. CPC H04W 28/0284; H04L 1/1812; H04W 88/04

(57) ABSTRACT

Apparatuses, methods, and systems are disclosed for improved communications using relay over sidelink radio interface. One apparatus includes a processor and a transceiver that transmits a data packet via a sidelink interface, where the data packet is transmitted to a first UE device and a second UE device. The transceiver receives a first HARQ feedback from the first UE device and receives a second HARQ feedback from the second UE device. Here, the first HARQ feedback indicating a decoding status of the data packet at the first UE device and the second HARQ feedback indicating a decoding status of the data packet at the second UE device. The processor determines to stop transmission of the data packet in response to at least one of the first and second HARQ feedback being a positive acknowledgement.

### CROSS-REFERENCE TO RELATED APPLICATIONS

This application claims priority to U.S. Provisional Patent Application No. 63/061,725 entitled “MECHANISMS FOR IMPROVED COMMUNICATIONS USING RELAY OVER SIDELINK RADIO INTERFACE” and filed on Aug. 5, 2020 for Prateek Basu Mallick, Joachim Loehr, Ravi Kuchibhotla, and Karthikeyan Ganesan, which application is incorporated herein by reference.

### FIELD

The subject matter disclosed herein relates generally to wireless communications and more particularly relates to mechanisms for improved communications using relay over sidelink radio interface.

### BACKGROUND

A SL relay is a potential means to increase coverage using one or multiple hops. For UE-to-network coverage extension, Uu coverage reachability is necessary for UEs to reach a server in a PDN network or a counterpart UE out of proximity area. For UE-to-UE coverage extension, currently proximity reachability is limited to single-hop sidelink link, either via EUTRA-based or NR-based sidelink technology.

### BRIEF SUMMARY

Disclosed are procedures for improved communications using relay over sidelink radio interface. Said procedures may be implemented by apparatus, systems, methods, or computer program products.

One method of a Transmitting Remote User Equipment (“Tx Remote UE”) for improved communications using relay over sidelink radio interface includes transmitting a data packet via a sidelink interface, where the data packet is transmitted to a first User Equipment (“UE”) device and a second UE device. The method includes receiving a first Hybrid Automatic Repeat Request (“HARQ”) feedback from the first UE device and receiving a second HARQ feedback from the second UE device. Here, the first HARQ feedback indicates a decoding status of the data packet at the first UE device and the second HARQ feedback indicates a decoding status of the data packet at the second UE device. The method includes determining to stop transmission of the data packet in response to at least one of the first and second HARQ feedback being a positive acknowledgement.

One method of a Sidelink Relay User Equipment (“SL Relay UE”) for improved communications using relay over sidelink radio interface includes receiving a data packet from a first UE device via a first sidelink interface, transmitting a first HARQ feedback to the first UE device in response to successfully decoding the data packet, and transmitting the data packet to a second UE device via a second sidelink interface.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for improved communications using relay over sidelink radio interface;

FIG. 2A is a block diagram illustrating one embodiment of a relay arrangement for sending a Transport Block (“TB”) via unicast transmission;

FIG. 2B is a block diagram illustrating one embodiment of a Sidelink (e.g., PC5) protocol stack;

FIG. 3A is a block diagram illustrating one embodiment of a relay arrangement for the use of multiple relays to unicast the same TB;

FIG. 3B is a block diagram illustrating one embodiment of Source Identifier (“ID”) and Destination ID mappings for the interfaces of FIG. 3A;

FIG. 4A is a block diagram illustrating one embodiment of a relay arrangement for the use of multiple relays and a direct path to transmit the same TB;

FIG. 4B is a block diagram illustrating one embodiment of Source ID and Destination ID mappings for the interfaces of FIG. 4A;

FIG. 4C is a block diagram illustrating another embodiment of Source ID and Destination ID mappings for the interfaces of FIG. 4A;

FIG. 5 is a block diagram illustrating one embodiment of a 5G New Radio (“NR”) protocol stack;

FIG. 6 is a block diagram illustrating one embodiment of a user equipment apparatus that may be used for improved communications using relay over sidelink radio interface;

FIG. 7 is a block diagram illustrating one embodiment of a network equipment apparatus that may be used for improved communications using relay over sidelink radio interface;

FIG. 8 is a block diagram illustrating one embodiment of a first method for improved communications using relay over sidelink radio interface; and

FIG. 9 is a block diagram illustrating one embodiment of a second method for improved communications using relay over sidelink radio interface.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for mechanisms for improved communications using relay over sidelink radio interface. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

As described above, two types of relays are considered herein:
1) UE-to-network relay (also referred to as “N-relay”): Uu coverage reachability is necessary for UEs to reach server in Packet Data Network (“PDN”) or counterpart UE out of proximity area. However, N-relay solution previously defined in 3GPP Rel-13 is limited to Evolved Universal Terrestrial Radio Access (“EUTRA”)-based technology, and thus cannot be applied to NR-based system, for both Next-Generation (i.e., 5G) Radio Access Network (“NG-RAN”) and NR-based sidelink communication.
2) UE-to-UE relay (also referred to as “UE-relay”): Currently, proximity reachability is limited to single-hop sidelink link, either via EUTRA-based or NR-based sidelink technology. However, that is not sufficient in the scenario where there is no Uu coverage (i.e., the UE is outside of RAN coverage), considering the limited single-hop sidelink coverage.

For both SL relay types, a SL remote UE needs to discover and select a Relay for transmissions to a SL Remote. The reliability requirement already is 10\hat{ }5 (e.g., PQI 91, shown in Table 1) and may only increase further with the introduction of Public Safety. In addition, other communication applications—like Industrial Internet-of-Things (“IIoT”), and others—are to start using sidelink and require not only even higher reliability, but also extended coverage. A SL relay is a potential means to increase coverage using one or multiple hops. Described herein are methods to achieve higher reliability as well as coverage.

TABLE 1
Standardized PQI to QoS characteristics mapping (From 3GPP TS 23.287)

| | | | | | | Default | | |
|---|---|---|---|---|---|---|---|---|
| | | Default | Packet | | Packet | Maximum | Default | |
| PQI | Resource | Priority | Delay | | Error | Data Burst | Averaging | |
| Value | Type | Level | Budget | | Rate | Volume | Window | Example Services |
| 21 | GBR | 3 | 20 | ms | 10⁻⁴ | N/A | 2000 ms | Platooning between |
| | | | | | | | | UEs - Higher degree |
| | | | | | | | | of automation; |
| | | | | | | | | Platooning between |
| | | | | | | | | UE and Road Side |
| | | | | | | | | Unit (“RSU”) - |
| | | | | | | | | Higher degree of |
| | | | | | | | | automation |
| 22 | (NOTE 1) | 4 | 50 | ms | 10⁻² | N/A | 2000 ms | Sensor sharing - |
| | | | | | | | | higher degree of |
| | | | | | | | | automation |
| 23 | | 3 | 100 | ms | 10⁻⁴ | N/A | 2000 ms | Information sharing |
| | | | | | | | | for automated |
| | | | | | | | | driving - between |
| | | | | | | | | UEs or UE and RSU - |
| | | | | | | | | higher degree of |
| | | | | | | | | automation |
| 55 | Non- | 3 | 10 | ms | 10⁻⁴ | N/A | N/A | Cooperative lane |
| | GBR | | | | | | | change - higher |
| | | | | | | | | degree of automation |
| 56 | | 6 | 20 | ms | 10⁻¹ | N/A | N/A | Platooning |
| | | | | | | | | informative |
| | | | | | | | | exchange - low |
| | | | | | | | | degree of |
| | | | | | | | | automation; |
| | | | | | | | | Platooning - |
| | | | | | | | | information sharing |
| | | | | | | | | with RSU |
| 57 | | 5 | 25 | ms | 10⁻¹ | N/A | N/A | Cooperative lane |
| | | | | | | | | change - lower |
| | | | | | | | | degree of automation |
| 58 | Non- | 4 | 100 | ms | 10⁻² | N/A | N/A | Sensor information |
| | GBR | | | | | | | sharing - lower |
| | | | | | | | | degree of automation |
| 59 | | 6 | 500 | ms | 10⁻¹ | N/A | N/A | Platooning - |
| | | | | | | | | reporting to an RSU |
| 90 | Delay | 3 | 10 | ms | 10⁻⁴ | 2000 bytes | 2000 ms | Cooperative collision |
| | Critical | | | | | | | avoidance; |
| | GBR | | | | | | | Sensor sharing - |
| | | | | | | | | Higher degree of |
| | | | | | | | | automation; |
| | | | | | | | | Video sharing - |
| | | | | | | | | higher degree of |
| | | | | | | | | automation |
| 91 | (NOTE 1) | 2 | 3 | ms | 10⁻⁵ | 2000 bytes | 2000 ms | Emergency |
| | | | | | | | | trajectory alignment; |
| | | | | | | | | Sensor sharing - |
| | | | | | | | | Higher degree of |
| | | | | | | | | automation |

(NOTE 1):
Guaranteed Bit Rate (“GBR”) and Delay Critical GBR PQIs can only be used for unicast PC5 communications.

Multi Relay for NR sidelink is a new study. In previous systems like EUTRA, the related concept of Hybrid Automatic Repeat Request (“HARQ”) feedback was not used and therefore there is not a direct conventional solution available using relay scenarios for increasing reliability and/or coverage.

This disclosure describes many solution cases whereby a remote transmitter device may use one or more relays and may optionally also use a direct link in communicating to a remote receiver device. As used here, a Relay device or Relay UE may refer to either the N-relay or UE-relay scenarios described above. To make the system optimal, multiple enhancements are done to achieve maximum reliability and system efficiency. The solutions revolve around novel HARQ feedback transmission, reception methods whereby not only the transmitter but also the potential transmitters may determine if they should as well transmit the same data packet to the remote receiver device.

There are no previous solutions in NR system wherein a Relay is used in sidelink to increase reliability. There are no previous solutions in 3GPP when the sidelink communication using relays utilizes sidelink HARQ feedback-based retransmissions. Because a relay is used to reach a remote receiver UE that may otherwise may not be in communication range of the remote transmitter, the solutions revealed here not only increase reliability of transmission but increase coverage as well.

In one embodiment, a sidelink transmitter UE (also referred to herein as “UE1”) having determined that a sidelink receiver UE (also referred to herein as “UE3”) is not directly accessible, or at least not efficiently accessible, further decides whether to use just sidelink relay UE(s) (i.e., using one or more relays) or to also use a direct link to the UE3. In certain embodiments, the decision on using one of these different cases depends on the required reliability, as well as on Channel Busy Ratio (“CBR”) or other channel quality metrics.

In another embodiment, as a result of the handshake procedure, a Relay UE (also referred to herein as “UE2”) may “adopt” the source ID of the UE3 as one of its own source identities and therefore transmissions received with destination identity set to DST of the UE3 is not filtered out when coming from SRC of the UE 1.

In some embodiments, two HARQ Feedback opportunities are used: the first (in time) opportunity is used by the sidelink receiver UE to transmit the HARQ Feedback, which opportunity is monitored by the sidelink transmitter UE and one or more sidelink relay UEs; while the second (in time) opportunity is used by any of the sidelink relay UEs and/or sidelink receiver UE to transmit ACK-only HARQ Feedback on a common resource, also linked by another offset to the physical resources (e.g., lowest Physical Resource Block (“PRB”) or subchannel) used for the transmission of the Transport Block (“TB”, e.g., a data packet) on the Interface-1.

In some embodiments, a new 1-bit flag (called “use-relay”) is used. When the flag is set to ‘TRUE,’ indicating “Tx from UE1 that needs to be relayed” (where “UE1” represents the sidelink transmitter UE), then the said two HARQ Feedback opportunities are used. When the flag is set to ‘FALSE,’ indicating “Tx from UE2” (where “UE2” represents the sidelink relay UE), then only one of the HARQ Feedback opportunities is used. In some embodiments, a second relay UE listens to a feedback from the sidelink receiver UE to a first relay is revealed, second relay transmits the corresponding TB if feedback from the sidelink receiver UE is NACK. As used herein, “HARQ-ACK” may represent collectively the Positive Acknowledge (“ACK”) and the Negative Acknowledge (“NACK”) and Discontinuous Transmission (“DTX”). Signaling ACK means that a Transport Block (“TB”) is correctly received. Signaling NACK (or NAK) means a TB is erroneously received (e.g., received but unsuccessfully decoded), while signaling DTX means that no TB was detected.

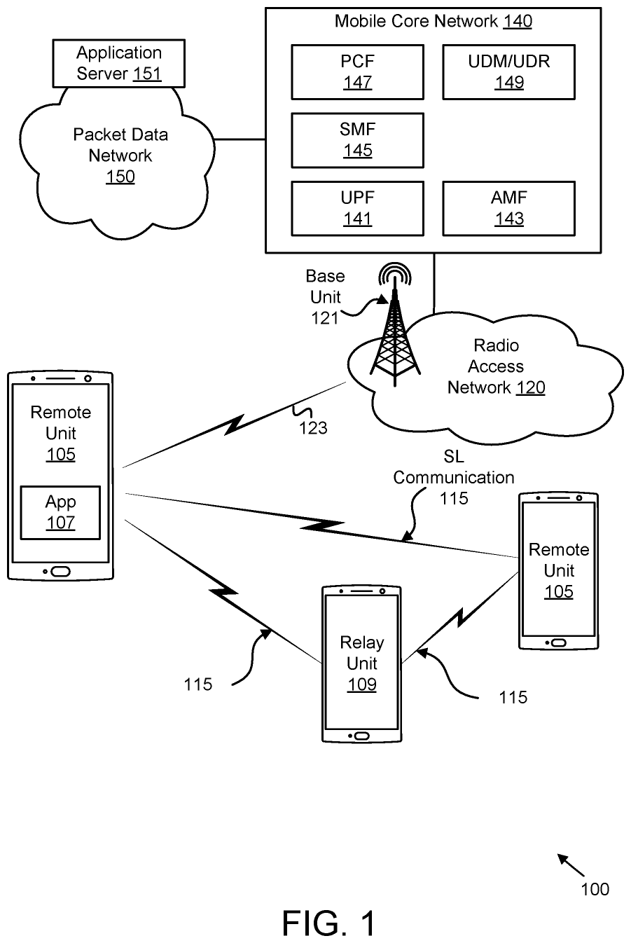

FIG. 1 depicts a wireless communication system 100 for improved communications using relay over sidelink radio interface, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM″”) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for improved communications using relay over sidelink radio interface apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station but it is replaceable by any other radio access node, e.g., gNB, ng-eNB, eNB, Base Station (“BS”), Access Point (“AP”), etc. Further, the operations are described mainly in the context of 5G NR. However, the below described solutions/methods are also equally applicable to other mobile communication systems improved communications using relay over sidelink radio interface.

In various embodiments, the remote units 105 may communicate directly with each other (e.g., device-to-device communication) using SL communication links 115. Here, SL transmissions may occur on SL resources. The remote units 105 implement SL HARQ processes for at least some data transferred over SL communication signals 115, as discussed in greater detail below.

In various embodiments, the transmitting remote unit 105 (i.e., source UE) may not be in range to transmit directly to the receiving remote unit 105 (i.e., destination UE). In such embodiments, the transmitting remote unit 105 may use one or more relay units 109 to reach the receiving remote unit. A relay unit 109 may be one embodiment of the remote unit 105, i.e., a UE configured to relay transmissions over SL communication links 115. The relay unit(s) 109 may relay both data packets and HARQ feedback, as discussed in greater detail below.

In NR V2X communication Rel. 16, SL HARQ feedback is used for groupcast and unicast communication to improve spectral efficiency. When SL HARQ feedback is enabled for unicast, in the case of non-Code Block Group (“CBG”) operation the receiver UE (“Rx UE,” i.e., receiving remote unit 105) generates HARQ-ACK if it successfully decodes the corresponding TB. The Rx UE generates HARQ-NACK if it does not successfully decode the corresponding TB after decoding the associated Physical Sidelink Control Channel (“PSCCH”) targeted to the Rx UE.

As for communicating feedback by the receiver UE(s) to the transmitter UE for a transmission made by the transmitter is concerned, following two options are available:

According to SL HARQ feedback Option 1, i.e., NACK only common feedback resource, all receiver(s) that failed to successfully decode the received Physical Sidelink Shared Channel (“PSSCH”) Data packet will send a HARQ NACK on the resource common to all the receivers. The HARQ NACK feedback is System Frame Number (“SFN”) combined over the air.

According to SL HARQ feedback Option 2, i.e., Rx UE-specific ACK/NACK feedback resources, every receiver that received PSCCH (i.e., containing Sidelink Control Information (“SCI”)) and attempted to decode corresponding PSSCH (i.e., containing SL Data) shall feedback HARQ ACK/NACK in the corresponding resources depending on if they were successful or not in decoding the Data packet.

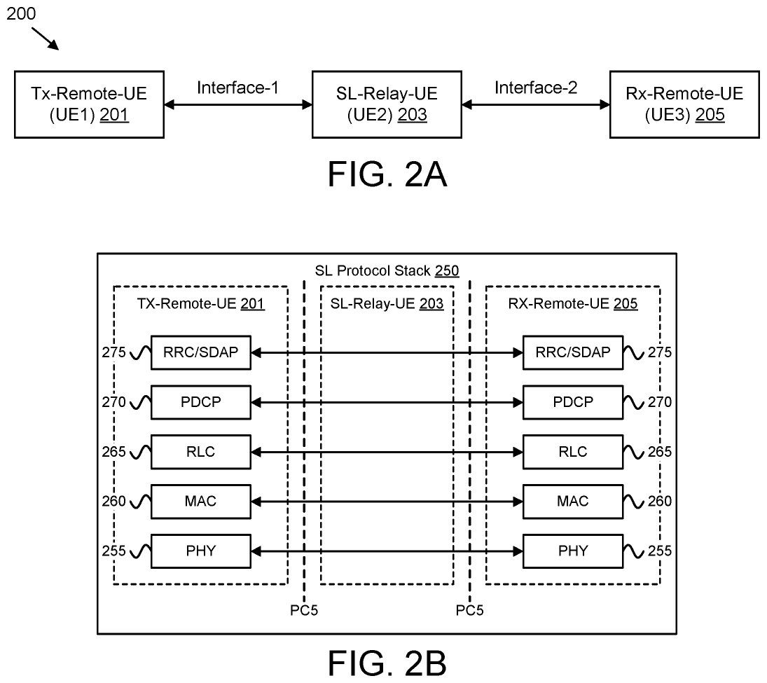

FIG. 2A is a block diagram illustrating one embodiment of a relay arrangement 200 for sending a TB via unicast transmission, according to the case of simple transmission referred to as “Case 1” (e.g., unicast on a first sidelink interface (depicted as “Interface-1”). The arrangement 200 involves a Tx-Remote-UE (i.e., UE1) 201 which is the UE that has some application data to be sent to another Remote UE, shown as Rx-Remote-UE (i.e., UE3) 205, via a SL-Relay-UE (i.e., UE2) 203. The UE2 203 then transmits (i.e., relays) the TB to UE3 205 over a second sidelink interface (depicted as “Interface-2”). At a different point in time, the UE3 205 may have data to send to the UE1 201 via the UE2 203 and, in this context, the UE3 205 would take the role of a transmitter UE. There the terms and roles shown in FIG. 2A, are with respect to a particular data packet (i.e., TB) only.

In some cases, more than one Relay UEs are available for use, e.g., UE2a and UE2b: “UE2” is a generalized representation of either or both of these. For groupcast and broadcast communication, UE3 205 is a representation of all Rx-Remote-UEs. Note that in further embodiments, a Rx-Remote-UE may act as a Relay UE to another destination UE (i.e., UE4), not shown in the FIG. 2A.

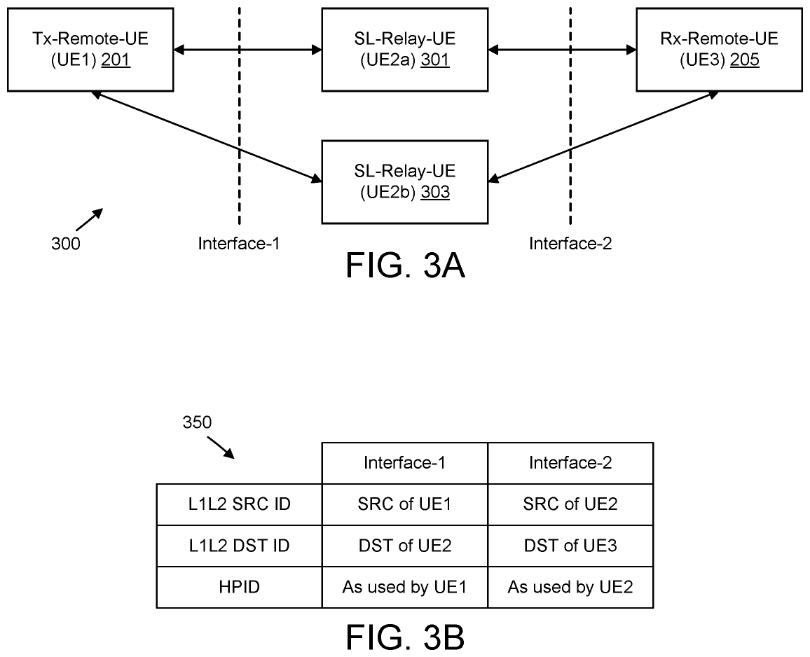

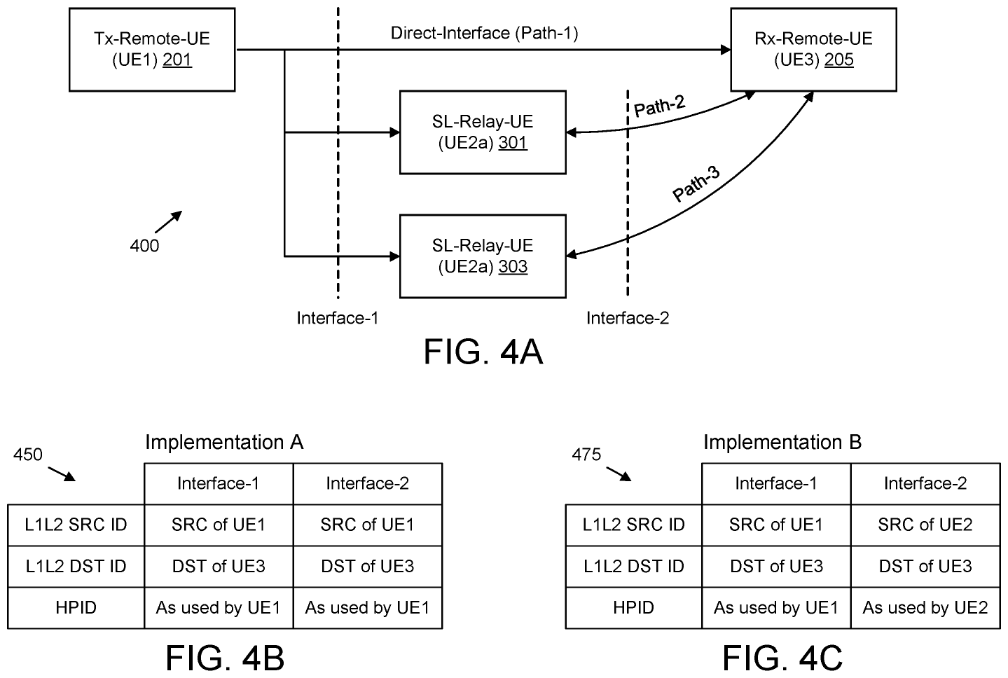

According to embodiments of a first solution, the Tx-Remote-UE 201 having determined that SL-Relay-UE 203 is not directly accessible, or at least not efficiently, further decides if it will use just one or more relays, and if a direct link to SL-Relay-UE 203 may be used as well. FIG. 2A shows one example of a relay according to the first solution. Other possible relay arrangements are depicted in FIG. 3A and FIG. 4A.

The decision on using one of these different cases may depend on the required reliability as well as on CBR. For highest levels of required reliability, Case 3 of FIG. 4A may be used if the CBR is above a threshold and if the required reliability is a bit less than the highest levels of required reliability and CBR is also not very high, Case 2 of FIG. 3A may be used. Also, it may be noted that a sidelink UE (peer remote UE and/or relay UE) may not support all these cases and therefore, they may need to mutually agree on a possible case solution to be used among them. The same may be also controlled by the network using (pre)configuration or specification.

FIG. 2B depicts a PC5 protocol stack 250, according to embodiments of the disclosure. While FIG. 2B shows the Tx-Remote-UE 201, the SL-Relay-UE 203, and the Rx-Remote-UE 205, these are representative of a set of UEs communicating peer-to-peer via PC5 and other embodiments may involve different UEs. As depicted, the PC5 protocol stack includes a physical (“PHY”) layer 755, a Media Access Control (“MAC”) sublayer 760, a Radio Link Control (“RLC”) sublayer 765, a Packet Data Convergence Protocol (“PDCP”) sublayer 770, and Radio Resource Control (“RRC”) and Service Data Adaptation Protocol (“SDAP”) layers (depicted as combined element “RRC/SDAP” 775), for the control plane and user plane, respectively.

The AS protocol stack for the control plane in the PC5 interface consists of at least RRC, PDCP, RLC and MAC sublayers, and the physical layer. The AS protocol stack for the user plane in the PC5 interface consists of at least SDAP, PDCP, RLC and MAC sublayers, and the physical layer. The L2 is split into the SDAP, PDCP, RLC and MAC sublayers. The L3 includes the RRC sublayer for the control plane and includes, e.g., an IP layer for the user plane. L1 and L2 are referred to as “lower layers”, while L3 and above (e.g., transport layer, V2X layer, application layer) are referred to as “higher layers” or “upper layers.”

In some embodiments, the SL-Relay-UE 203 acts as a L3 relay (also referred to as an IP relay). Here, communication between the Tx-Remote-UE 201 (i.e., source UE) and the Rx-Remote-UE 205 (i.e., target UE) via L3 relay goes through two combined PC5 links, i.e., a first PC5 link (corresponding to Interface-1) between the Tx-Remote-UE 201 and the SL-Relay-UE 203 and a second PC5 link (corresponding to Interface-2) between the SL-Relay-UE 203 and the Rx-Remote-UE 205. In such embodiments, the protocol stack of the SL-Relay-UE 203 may include SDAP, RRC, PDCP, RLC, MAC and PHY layers which interact with corresponding layers at the Tx-Remote-UE 201 via the Interface-1, and which also interact with corresponding layers at the Rx-Remote-UE 205 via the Interface-2. As described in further detail below, the SL-Relay-UE 203 may adopt one or more L1 and/or L2 identities of the Tx-Remote-UE 201 to improve communication over sidelink relay interface.

In some embodiments, the SL-Relay-UE 203 acts as a L2 relay. In certain embodiments, the SL-Relay-UE 203 acting as a L2 relay performs relay function below the PDCP layer 770, such that the SL-Relay-UE 203 does not perform PDCP, RRC and SDAP functions for the SL communication. In such embodiments, the protocol stack of the SL-Relay-UE 203 may include RLC layer 765, MAC layer 760 and PHY layer 755 entities which interact with corresponding layers at the Tx-Remote-UE 201 via the Interface-1, and which interact with corresponding layers at the Rx-Remote-UE 205 via the Interface-2. However, for the PDCP layer 770, the RRC and SDAP layers 775, the link endpoints are between the Tx-Remote-UE 201 and the Rx-Remote-UE 205.

In some embodiments, the SL-Relay-UE 203 acts as a L1 relay (also referred to as an Amplify and Forward relay) with HARQ functionality. In certain embodiments, the protocol stack of the SL-Relay-UE 203 may have PHY layer 755 and a HARQ entity (i.e., of the MAC layer 760) which interact with corresponding layers at the Tx-Remote-UE 201 via the Interface-1, and which interact with corresponding layers at the Rx-Remote-UE 205 via the Interface-2. However, for the remaining layers, the link endpoints are between the Tx-Remote-UE 201 and the Rx-Remote-UE 205.

Note that the above relay descriptions are exemplary, and the SL-Relay-UE 203 is not limited to the above-described relay implementations. Thus, the SL-Relay-UE 203 may implement different protocol stacks and/or link endpoints than those described above, according to the below described solutions.

FIG. 3A is a block diagram illustrating one embodiment of a relay arrangement 300 to send a TB, according to a second case involving the use of multiple relays to transmit the same TB to a Rx-Remote-UE 205 referred to as “Case 2” (e.g., making two or more unicast transmissions on a first sidelink interface (depicted as “Interface-1”). The arrangement 300 involves the Tx-Remote-UE (i.e., UE1) 201 which is the UE that has some application data to be sent to another Remote UE, shown as Rx-Remote-UE (i.e., UE3) 205, via multiple parallel Relays (i.e., a first SL-Relay-UE (i.e., “UE2a”) 301 and a second SL-Relay-UE (“UE2b”) 303). At a different point in time, the UE3 205 may have data to send to UE1 201 via UE2a 301 and/or UE2b 303 and, in this context, the UE3 205 would take the role of a transmitter UE.

As depicted in FIG. 3A, two separate unicast transmissions are made by the UE1 201 over Interface-1: a first unicast transmission to the UE2a 301 and a second unicast transmission to the UE2b 303. A relay (i.e., UE2a 301 and/or UE2b 303) then transmits the TB to UE3 205 over a second sidelink interface (depicted as “Interface-2”). Here, the Interface-2 could be Unicast (“UC”) or Groupcast (“GC”), as indicated by UE1 201 to UE2a 301 and UE2b 303. Alternatively, the Interface-2 could be Broadcast (“BC”), as indicated by UE1 201 to UE2a 301 and UE2b 303. In FIG. 3A, only one UE3 205 is shown, but it is representative of one of multiple receivers for the GC or BC case.

According to embodiments of a second solution, when using one or more relays the behavior of all the UEs (UE1, UE2 and UE3) are described with response to: which L1 IDs and L2 IDs are to be used, how HARQ feedback is to be received, and when the Tx-Remote-UE (UE1) 201 is to stop transmission of the TB.

FIG. 3B is a block diagram illustrating one embodiment of a table 350 of Source L1/L2 ID and Destination L1/L2 ID on Interface-1 and Interface-2, assuming the relay arrangement of FIG. 3A. Regarding which Layer-1 IDs and Layer-2 IDs are used on each interface, the Source (“SRC”) L2 IDs and Destination (“DST”) L2 IDs are as shown in FIG. 3B. FIG. 3B also shows which HARQ process IDs (“HPIDs”) are to be used for each Interface. Note that at the Tx-Remote-UE (UE1) 201, the Source Layer-2 ID set to the identifier provided by upper layers, e.g., as defined in TS 23.287. The length of the field is 24 bits. Similarly, at the Tx-Remote-UE 201 the Destination Layer-2 ID set to the identifier provided by upper layers, e.g., as defined in TS 23.287. The length of the field is also 24 bits.

Regarding how HARQ feedback is to be received, in one embodiment, the Tx-Remote-UE 201 may stop retransmission and flush the HARQ buffer if one of the first SL-Relay-UE 301 or the second SL-Relay-UE 303 indicates a positive ACK. Further, the SL Relay UE sending ACK Feedback may take over the transmission towards UE3. For example, if only the first SL-Relay-UE 301 sends an ACK indication to the Tx-Remote-UE 201, then the first SL-Relay-UE 301 will also relay the TB towards the Rx-Remote-UE 205. In this embodiment, because the second SL-Relay-UE 303 does not receive the TB successfully, the second SL-Relay-UE 303 does not attempt to relay the TB to Rx-Remote-UE 205.

In another embodiment, the Tx-Remote-UE 201 may keep retransmitting to the other relay (i.e., UE2b) until it also receives the TB successfully and indicates a positive ACK. At this point, the Tx-Remote-UE 201 stops retransmission and flushes HARQ buffer. Continuing the earlier example, the Tx-Remote-UE 201 would keep retransmitting to the second SL-Relay-UE 303 until the second SL-Relay-UE 303 indicates HARQ ACK (or until a maximum number of retransmissions is reached). Upon sending ACK feedback, the second SL-Relay-UE 303 starts transmitting the TB to the Rx-Remote-UE 205. When the Rx-Remote-UE 205 successfully receives the same TB from both the first SL-Relay-UE 301 and the second SL-Relay-UE 303, the Rx-Remote-UE 205 discards the duplicate TB at the PDCP layer, e.g., using a PDCP Serial Number (“SN”). For this purpose, the PDCP at Tx-Remote-UE 201 may transmit duplicate PDCP PDUs to two different RLC entities, one RLC entity for each Relay/link.

For HARQ feedback, a Physical Sidelink Feedback Channel (“PSFCH”) may be used for all four links shown in FIG. 3A (i.e., UE1-to-UE2a, UE1-to-UE2b, UE2a-to-UE3, and UE2b-to-UE3).

FIG. 4A is a block diagram illustrating one embodiment of a relay arrangement 400 to send a TB, according to a third case involving the use of multiple relays and a direct path to transmit the same TB to the Rx-Remote-UE (i.e., making single groupcast transmissions on Interface-1, referred to as “Case 3”). The arrangement 400 involves the Tx-Remote-UE (UE1) 201 which is the UE that has some application data to be sent to another Remote UE, shown as Rx-Remote-UE (UE3) 205, via multiple parallel Relays (i.e., the first SL-Relay-UE 301 and the second SL-Relay-UE 303) and/or via a direct-interface. The direct-interface between the Tx-Remote-UE 201 and the Rx-Remote-UE 205 is referred to as “Path-1”. The interface between the first SL-Relay-UE 301 and the Rx-Remote-UE 205 is referred to as “Path-2”. The interface between the second SL-Relay-UE 303 and the Rx-Remote-UE 205 is referred to as “Path-3”. At a different point in time, the UE3 205 may have data to send to UE1 201 via UE2a/b 301/303 and/or via Path-1, and in this context the UE3 205 would take the role of a transmitter UE.

As depicted in FIG. 4A, a groupcast transmission is made by the UE1 201 over Interface-1 (including the direct-interface/Path-1 and links to UE2a and UE2b). A Relay UE may transmit the TB to the UE3 205 over Path-2 or Path-3. Note that the Interface-2 (i.e., sidelink interface between UE2a/2B and UE3) could be UC or GC as indicated by UE1 to UE2a/b. Alternatively, the Interface-2 could be BC as indicated by UE1 to UE2a/2b. In FIG. 4A, only one UE3 is shown, but it is representative of one of multiple receiver UEs of a GC or BC case.

FIG. 4B is a block diagram illustrating one embodiment of a table 450 of Source L1/L2 ID and Destination L1/L2 ID on Interface-1 and Interface-2 according to Implementation A, assuming the relay arrangement of FIG. 4A.

FIG. 4C is a block diagram illustrating another embodiment of a table 475 of Source L1/L2 ID and Destination L1/L2 ID on Interface-1 and Interface-2 according to Implementation B, assuming the relay arrangement of FIG. 4A.

Regarding which Layer-1 IDs and Layer-2 IDs are used and how HARQ feedback is to be received, as a result of the handshake procedure, the SL Relay UEs (i.e., first SL-Relay-UE 301 and/or second SL-Relay-UE 303) may “adopt” the source ID of the Rx-Remote-UE 205 as one of their own source identities and therefore transmissions received with destination identity set to DST of Rx-Remote-UE 205 is not filtered out when coming from SRC of Tx-Remote-UE 201.

As described above, two HARQ feedback (“HF”) opportunities may be used for Case 3, and this may be indicated by the SCI (PSCCH) on the Interface-1 the Tx-Remote-UE 201. This can be achieved by 1-bit flag (called “use-relay”). In one embodiment, the value TRUE=“Tx from UE1 that needs to be relayed” and then the two HF opportunities are used. Here, the value FALSE=“Tx from UE2” and then only one HF opportunity is used (e.g., as in 3GPP Rel-16).

In some embodiments, both the HF opportunities are linked by an offset to the physical resources (e.g., lowest PRB, subchannel) used for the transmission of the TB on the Interface-1. The first (in time) opportunity is used by the Rx-Remote-UE 205 to transmit the HF, and this is monitored by the Tx-Remote-UE 201 and the first SL-Relay-UE 301 and/or the second SL-Relay-UE 303. The second (in time) opportunity is used by any of the first SL-Relay-UE 301, the second SL-Relay-UE 303 and/or the Rx-Remote-UE 205 to transmit an ACK-only feedback on a common resource also linked by another offset to the physical resources (e.g., lowest PRB, subchannel) used for the transmission of the TB on the Interface-1.

According to SL HARQ Feedback Option 1 (i.e., NACK-only, common feedback resource), all receiver(s) that failed to successfully decode the received PSSCH Data packet will send a HARQ NACK on the resource common to all the receivers. The HARQ NACK feedback is SFN combined over the air.

According to SL HARQ Feedback Option 2 (i.e., Rx UE-specific ACK/NACK feedback resources), every receiver that received PSCCH (SCI) and attempted to decode corresponding PSSCH (Data) shall feedback HARQ ACK/NACK in the corresponding resources depending on if they were successful or not in decoding the Data packet.

According to a new SL HARQ Feedback option (i.e., Option 3 or ACK-only common feedback resource), all receiver(s) that successfully decoded the received PSSCH Data packet will send a HARQ ACK on the resource common to all the receivers. In certain embodiments, the HARQ ACK feedback is SFN combined over the air.

In some embodiments, SL Relay UE(s) having successfully received the TB may begin transmitting/relaying the TB prior to the first HF opportunity. For example, if the first HF opportunity appears later than a possible transmission to the Rx-Remote-UE 205, then the SL Relay UE(s) could start transmitting the TB received from the Tx-Remote-UE 201 prior to the first HF opportunity. However, in other embodiments, the SL Relay UE(s) having successfully received the TB do not begin transmitting/relaying the TB prior to the first HF opportunity. In such embodiments, said SL Relay UE(s) may evaluate HARQ feedback from the Rx-Remote-UE 205 in the first HF opportunity and selectively transmit/relay the TB depending on whether the Rx-Remote-UE 205 indicates successful reception of the TB.

As mentioned above, two slightly different implementations of Case 3 are possible, referred to as “Implementation A” and “Implementation B.” Table 2 shows HARQ feedback details for Implementation A, while Table 3 shows HARQ feedback details for Implementation B.

It is assumed that the first SL-Relay-UE 301 successfully receives the TB (and signals ACK to the Tx-Remote-UE 201) prior to the second SL-Relay-UE 303. Here, the second SL-Relay-UE 303 may continue attempting to receive the TB from the Tx-Remote-UE 201 and, upon success, initiate its own transmission to the Rx-Remote-UE 205, if the Rx-Remote-UE 205 has not so far indicated an ACK for the same TB. Transmission on Interface-2 are made using SL HARQ Feedback Option 2 and only the Rx-Remote-UE 205 sends HARQ feedback (i.e., PSFCH allocation to the Rx-Remote-UE 205 only as in case of unicast transmission using SL HARQ Feedback Option 2), the second SL-Relay-UE 303 also monitors the feedback from the Rx-Remote-UE 205.

TABLE 2

| First HF | 2^{nd} HF | |
|---|---|---|
| Opportunity | Opportunity | |
| (UE3) | (UE2a, 2b and UE3) | Result |
| ACK | Not used (or ACK | Successful (i.e., UE1 stops Tx of TB and UE2a, 2b |
| | transmission by UE3) | flushes HARQ/soft buffer) |
| NACK | ACK from UE2a | UE1 stops Tx of TB and flushes HARQ buffer (in another |
| | | implementation variation, the UE1 may still continue |
| | | transmission of the TB towards UE3 until UE3 sends an |
| | | Ack. Duplicates, if any will be discarded by UE3 at PDCP |
| | | or above.). UE2a takes over from next Redundancy |
| | | Version (“RV”). UE1 waits for final feedback. UE3 |
| | | makes HARQ feedback transmission on Rel-16 like |
| | | PSFCH channel for transmission using Rel-16 SCI |
| | | (PSCCH) format, i.e., not containing “use-relay” flag; |
| | | and/or when the SCI has “use-relay” but is set to FALSE. |
| NACK | No ACKs (DTX) | Re-Tx of TB by UE1 |

TABLE 3

| First HF | 2^{nd} HF | |
|---|---|---|
| Opportunity | Opportunity | |
| (UE3) | (UE2a, 2b and UE3) | Result |
| ACK | Not used (or ACK | Successful (i.e., UE1 stops Tx of TB and UE2a, 2b |
| | transmission by UE3) | flushes HARQ/soft buffer) |
| NACK | ACK from UE2a | UE1 stops Tx of TB and flushes HARQ buffer. UE2a |
| | | takes over from initial RV. UE1 waits for final feedback |
| | | from UE2a and only then it starts to transmit the next TB. |
| | | UE2b clears it HARQ buffer using a timer after not |
| | | receiving retransmission anymore or upon receiving a new |
| | | transmission (New Data Indicator (“NDI”) toggled) from |
| | | UE1 for the same HPID. |
| | | In another implementation variation, the UE1 may still |
| | | continue transmission of the TB towards UE3 until UE3 |
| | | sends an Ack. If before this, the UE2b also receives the |
| | | TB successfully but the UE3 not, UE2b can start |
| | | transmission of the TB to UE3. Duplicates, if any will be |
| | | discarded by UE3 at PDCP or above. |
| NACK | No ACKs (DTX) | Re-Transmission (“Re-Tx”) of TB by UE1 |

According to another implementation (“Implementation C”) of Case 3, after having received the TB (on Interface-1) successfully, the Tx-Remote-UE 201 and the SL Relay UE(s) take turns in transmitting the TB to the Rx-Remote-UE 205. This may be based on prior agreement between them. For example, the Tx-Remote-UE 201 may transmit on even-numbered transmission opportunities, while the SL Relay UE(s) may transmit on odd-numbered transmission opportunities.

According to a further implementation (“Implementation D”) of Case 3, the SL Relay UE(s) (i.e., first SL-Relay-UE 301 and/or second SL-Relay-UE 303) and the Rx-Remote-UE 205 may transmit ACK-only HARQ feedback (i.e., according to HARQ feedback Option 3, described above) on a common resource, also linked by another offset to the physical resources (e.g. lowest PRB, subchannel) used for the transmission of the TB on the Interface-1 by the Tx-Remote-UE 201. The Tx-Remote-UE 201 stops transmission of the TB after receiving an Ack and clears its buffer. If the ACK was from one of the SL Relay UE(s) (i.e., first SL-Relay-UE 301 and/or second SL-Relay-UE 303), then the SL Relay UE(s) will take over the transmission of the TB to the Rx-Remote-UE 205, as described in any of the previous implementations. Here, the SL Relay UE(s) may stops transmitting the TB only after receiving an ACK indication from the Rx-Remote-UE 205. Again, duplicates, if any will be discarded by the Rx-Remote-UE 205 at PDCP layer (or above).

According to a third solution, the Tx-Remote-UE 201 may keep changing between different cases for transmission towards different Rx-Remote-UE(s) or even to the same Rx-Remote-UE, but for different bearer and/or QoS flows. Additionally, the Tx-Remote-UE 201 may occasionally or periodically perform direct transmission to the Rx-Remote-UE 205, i.e., by setting the “use-relay” to FALSE. Performing the direct transmission helps the Tx-Remote-UE 201 to evaluate the direct link between itself and the Rx-Remote-UE 205.

While the in the above descriptions the SL Relay UE(s) (i.e., SL-Relay-UE (UE2) 203, first SL-Relay-UE (UE2a) 301, and/or second SL-Relay-UE (UE2b) 303) relay communications from one UE to another, in other embodiments the SL Relay UE(s) relay communication between a UE and the network

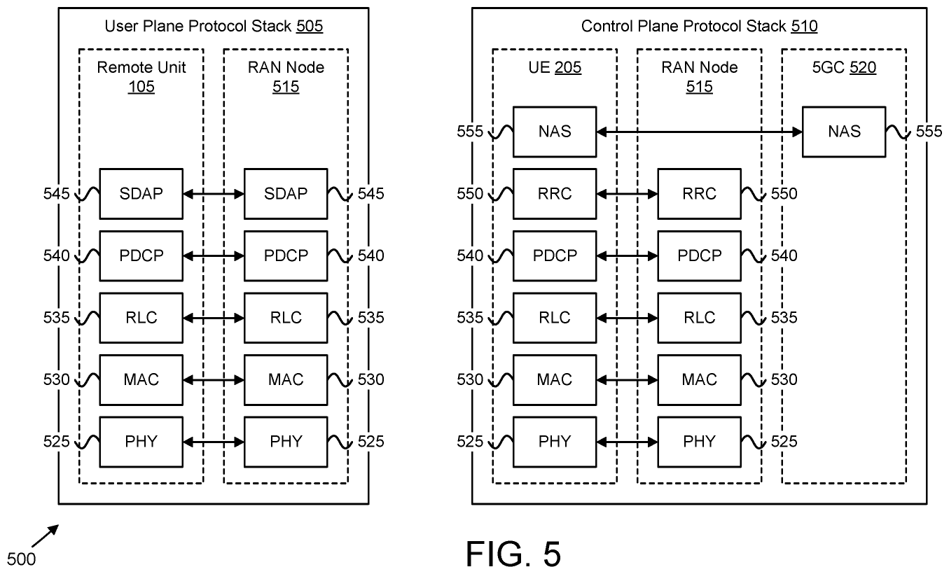

FIG. 5 depicts a protocol stack 500, according to embodiments of the disclosure. While FIG. 5 shows a remote unit 105 (i.e., a UE, such as the SL-Relay-UE (UE2) 203, first SL-Relay-UE (UE2a) 301, and/or second SL-Relay-UE (UE2b) 303), a RAN node 515 (i.e., an embodiment of the base unit 121) and the 5G core (“5GC”) 520 (i.e., an embodiment of the mobile core network 140), these are representative of a set of UEs interacting with a RAN node and a NF (e.g., AMF) in a core network. As depicted, the protocol stack 500 comprises a User Plane protocol stack 505 and a Control Plane protocol stack 510. The User Plane protocol stack 505 includes a physical (“PHY”) layer 515, a Medium Access Control (“MAC”) sublayer 520, a Radio Link Control (“RLC”) sublayer 525, a Packet Data Convergence Protocol (“PDCP”) sublayer 530, and Service Data Adaptation Protocol (“SDAP”) layer 535. The Control Plane protocol stack 510 also includes a physical layer 515, a MAC sublayer 520, a RLC sublayer 525, and a PDCP sublayer 530. The Control Place protocol stack 510 also includes a Radio Resource Control (“RRC”) layer and a Non-Access Stratum (“NAS”) layer 545.

The AS protocol stack for the Control Plane protocol stack 510 consists of at least RRC, PDCP, RLC and MAC sublayers, and the physical layer. The AS protocol stack for the User Plane protocol stack 505 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 540 and the NAS layer 545 for the control plane and includes, e.g., an Internet Protocol (“IP”) layer or PDU Layer (note depicted) for the user plane. L1 and L2 are referred to as “lower layers” such as Physical Uplink Control Channel (“PUCCH”) and/or Physical Uplink Shared Channel (“PUSCH”) or MAC Control Element (“CE”), while L3 and above (e.g., transport layer, application layer) are referred to as “higher layers” or “upper layers” such as RRC.

The physical layer 515 offers transport channels to the MAC sublayer 520. The MAC sublayer 520 offers logical channels to the RLC sublayer 525. The RLC sublayer 525 offers RLC channels to the PDCP sublayer 530. The PDCP sublayer 530 offers radio bearers to the SDAP sublayer 535 and/or RRC layer 540. The SDAP sublayer 535 offers QoS flows to the mobile core network 140 (e.g., 5GC). The RRC layer 540 provides for the addition, modification, and release of Carrier Aggregation and/or Dual Connectivity. The RRC layer 540 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

The SL Relay UE(s) relaying communication between a UE and the network may implement the PC5 protocol stack 250 on the SL interface (e.g., Interface-1) and implement the NR protocol stack 500 on the Uu interface (e.g., Interface-2).

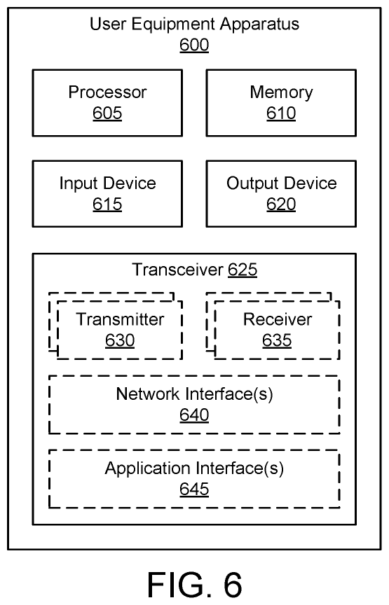

FIG. 6 depicts a user equipment apparatus 600 that may be used for improved communications using relay over sidelink radio interface, according to embodiments of the disclosure. In various embodiments, the user equipment apparatus 600 is used to implement one or more of the solutions described above. The user equipment apparatus 600 may be one embodiment of the remote unit 105, the Tx-Remote-UE 201, the SL-Relay-UE 203, the Rx-Remote-UE 205, the first SL-Relay-UE 301 and/or the second SL-Relay-UE 303, described above. Furthermore, the user equipment apparatus 600 may include a processor 605, a memory 610, an input device 615, an output device 620, and a transceiver 625.

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base units 121. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, the user equipment apparatus 600 operates as a remote Tx UE. In such embodiments, the transceiver 625 may transmit a data packet via sidelink interface, where the data packet is transmitted to a first UE device (i.e., the Rx Remote UE) and a second UE device (i.e., the SL Relay UE). The transceiver 625 receives a first HARQ feedback from the first UE device and receives a second HARQ feedback from the second UE device. Here, the first HARQ feedback indicating a decoding status of the data packet at the first UE device and the second HARQ feedback indicating a decoding status of the data packet at the second UE device. The processor 605 determines to stop transmission of the data packet in response to at least one of the first and second HARQ feedback being a positive acknowledgement.

In some embodiments, the first UE device comprises at least one sidelink remote receiver device and the second UE device comprises at least one sidelink relay device. In certain embodiments, the first HARQ feedback is received on a first HARQ feedback opportunity and the second HARQ feedback is received on a second HARQ feedback opportunity which occurs later in time than the first HARQ feedback opportunity.

In certain embodiments, the processor 605 waits for a final feedback acknowledgement from the second UE device before transmitting a next data packet when the first HARQ feedback indicates unsuccessful decoding of the data packet and the second HARQ feedback indicates successful decoding of the data packet. In certain embodiments, the data packet transmitted to the second UE device has a Layer-1 destination identity and a Layer-2 destination identity of the first UE device.

In some embodiments, the first UE device comprises a first sidelink relay device and the second UE device comprises a second sidelink relay device. In certain embodiments, the processor 605 determines a CBR of a direct link to a sidelink remote receiver device and further determines a level of required reliability for the data packet. In such embodiments, the processor 605 transmits to the first UE device and the second UE device in response to both the CBR being below a threshold limit and the level of required reliability being below a threshold level.

In some embodiments, the second HARQ feedback is a positive-acknowledgement-only feedback sent on common resources. In some embodiments, the processor 605 determines a level of required reliability for the data packet. In such embodiments, the processor 605 transmits to the first UE device and the second UE device in response to the level of required reliability being above a threshold level.

In some embodiments, the processor 605 determines a CBR of a link to the first UE device (e.g., direct link to Rx Remote UE). In such embodiments, the processor 605 transmits to the first UE device and the second UE device in response to the CBR being above a threshold limit. In some embodiments, based on a CBR and a level of required reliability for the data packet, the processor 605 determines a number of second UE devices to which to transmit the data packet. In some embodiments, the processor 605 implements a PDCP entity that duplicates the data packet to a first RLC entity and a second RLC entity, the first RLC entity being associated with an interface to the first UE device and the second RLC entity being associated with an interface to the second UE device.

In various embodiments, the user equipment apparatus 600 operates as a Relay UE. In such embodiments, the transceiver 625 may receive a data packet from a first UE device (i.e., Tx Remote UE) via a first sidelink interface and transmits a first HARQ feedback to the first UE device (e.g., via the first sidelink interface) in response to the processor 605 successfully decoding the data packet. The transceiver 625 transmits the data packet to a second UE device (i.e., Rx Remote UE) via a second sidelink interface.

In some embodiments, transmitting the data packet occurs in response to receiving a negative HARQ feedback from the second UE device. In certain embodiments, the transceiver 625 sends a final HARQ feedback to the first UE device in response to receiving a positive HARQ feedback from the second UE device for the data packet.

In certain embodiments, the received data packet has both Layer-1 and Layer-2 source identities of the first UE device and both Layer-1 and Layer-2 destination identities of the second UE device. In such embodiments, transmitting the data packet to a second UE device includes reusing the Layer-1 and Layer-2 source identities and the Layer-1 and Layer-2 destination identities of the received data packet.

In certain embodiments, the processor 605 reuses a HARQ process identity of the first UE device, where the received data packet has a first RV value. In such embodiments, transmitting the data packet includes generating a new HARQ retransmission packet corresponding to an incremented RV value of the data packet to a next RV value.

In certain embodiments, the received data packet has both Layer-1 and Layer-2 source identities of the first UE device and both Layer-1 and Layer-2 destination identities of the second UE device. In such embodiments, transmitting the data packet to a second UE device includes using the Layer-1 and Layer-2 source identities of the apparatus 600 and reusing the Layer-1 and Layer-2 destination identities of the received data packet, where the Layer-1 and Layer-2 source identities of the apparatus 600 are different than the Layer-1 and Layer-2 source identities contained in the received data packet.

In certain embodiments, the received data packet has a first RV value. In such embodiments, transmitting the data packet further includes incrementing the RV value and generating a HARQ retransmission packet for the data packet corresponding to a next RV value. In some embodiments, the processor 605 adopts a Layer-1 and Layer-2 source identity of the second UE device.

Note that in the above descriptions, the Rx Remote UE may instead be a RAN node or other network entity, whereby the SL Relay UE communicates with the Tx Remote UE using sidelink and relays communication between the Tx Remote UE and the, e.g., RAN node.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to improved communications using relay over sidelink radio interface. For example, the memory 610 may store various parameters, panel/beam configurations, resource assignments, policies, and the like as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a base unit 121, such as the UL transmissions described herein. Similarly, one or more receivers 635 may be used to receive DL communication signals from the base unit 121, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

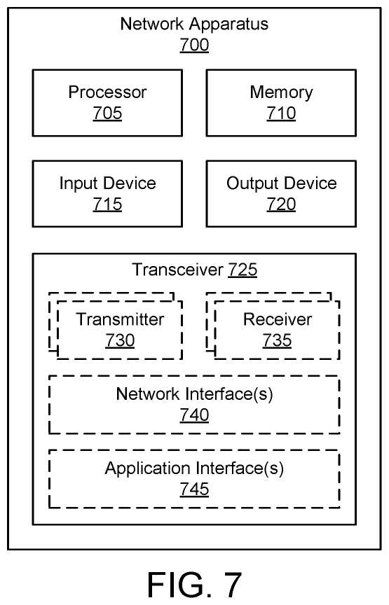

FIG. 7 depicts a network apparatus 700 that may be used for improved communications using relay over sidelink radio interface, according to embodiments of the disclosure. In one embodiment, network apparatus 700 may be one implementation of a RAN node, such as the base unit 121 and/or the RAN node 210, as described above. Furthermore, the base network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the network apparatus 700 is a RAN node (e.g., gNB) that communicates with one or more UEs, as described herein. In such embodiments, the processor 705 controls the network apparatus 700 to perform the above described RAN behaviors. When operating as a RAN node, the processor 705 may include an application processor (also known as “main processor”) which manages application-domain and operating system (“OS”) functions and a baseband processor (also known as “baseband radio processor”) which manages radio functions.

In various embodiments, the processor 705 controls the transceiver 725 to communicate with a UE via the SL-Relay-UE. In one embodiment, the SL-Relay-UE communicates with a Tx-Remote-UE using sidelink and relays communication between the Tx-Remote-UE and the apparatus 700. In another embodiment, the SL-Relay-UE communicates with a Rx-Remote-UE using sidelink and relays communication between the Rx-Remote-UE and the apparatus 700.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to improved communications using relay over sidelink radio interface. For example, the memory 710 may store parameters, configurations, resource assignments, policies, and the like, as described above. In certain embodiments, the memory 710 also stores program code and related data, such as an operating system or other controller algorithms operating on the apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with network functions in the PLMN and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

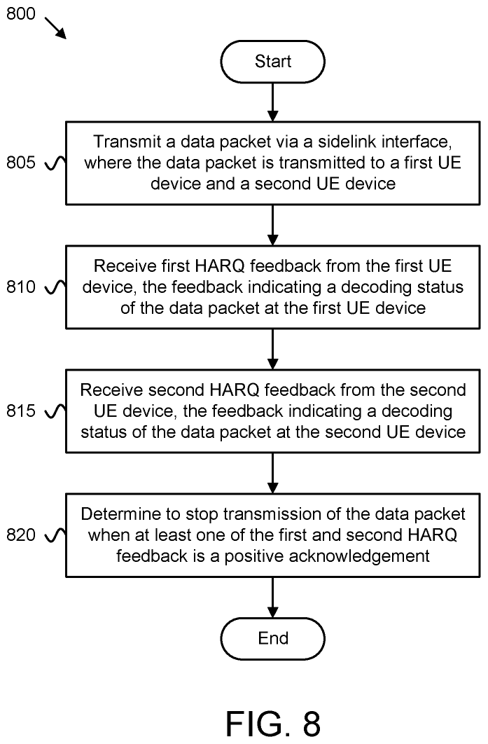

FIG. 8 depicts one embodiment of a method 800 for improved communications using relay over sidelink radio interface, according to embodiments of the disclosure. In various embodiments, the method 800 is performed by a sidelink transmitter UE device in a mobile communication network, such as the remote unit 105, the UE1 201, the UE3 205, and/or the user equipment apparatus 600, described above. In some embodiments, the method 800 is performed by a processor, such as a microcontroller, a microprocessor, a CPU, a GPU, an auxiliary processing unit, a FPGA, or the like.

The method 800 begins and transmits 805 a data packet via a sidelink interface, where the data packet is transmitted to a first UE device (i.e., at least one Rx Remote UE) and a second UE device (i.e., at least one SL Relay UE). The method 800 includes receiving 810 a first HARQ feedback from the first UE device, the first HARQ feedback indicating a decoding status of the data packet at the first UE device. The method 800 includes receiving 815 a second HARQ feedback from the second UE device, the second HARQ feedback indicating a decoding status of the data packet at the second UE device. The method 800 includes determining 820 to stop transmission of the data packet when at least one of the first and second HARQ feedback is a positive acknowledgement. The method 800 ends.

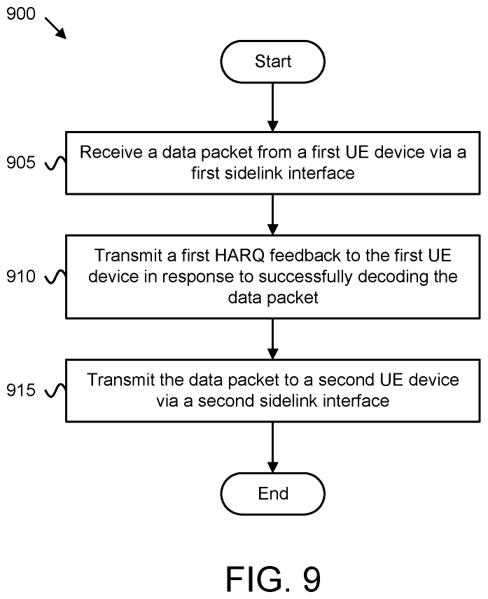

FIG. 9 depicts one embodiment of a method 900 for improved communications using relay over sidelink radio interface, according to embodiments of the disclosure. In various embodiments, the method 900 is performed by a sidelink relay UE device in a mobile communication network, such as the remote unit 105, the UE2 203, the UE2a 301, the UE2b 303, and/or the user equipment apparatus 600, described above. In some embodiments, the method 900 is performed by a processor, such as a microcontroller, a microprocessor, a CPU, a GPU, an auxiliary processing unit, a FPGA, or the like.

The method 900 begins and receives 905 a data packet from a first UE device (i.e., Tx Remote UE) via a first sidelink interface. The method 900 includes transmitting 910 a first HARQ feedback to the first UE device (e.g., via the first sidelink interface) in response to successfully decoding the data packet. The method 900 includes transmitting the data packet to a second UE device (i.e., Rx Remote UE) via a second sidelink interface. The method 900 ends.

Disclosed herein is a first apparatus improved communications using relay over sidelink radio interface, according to embodiments of the disclosure. The first apparatus may be implemented by a transmitting remote UE device in a mobile communication network, such as the remote unit 105, Tx-Remote-UE (i.e., UE1) 201, and/or the user equipment apparatus 600, described above. The first apparatus includes a processor and a transceiver that transmits a data packet via sidelink interface, where the data packet is transmitted to a first UE device (i.e., the Rx Remote UE) and a second UE device (i.e., the SL Relay UE). The transceiver receives a first HARQ feedback from the first UE device and receives a second HARQ feedback from the second UE device. Here, the first HARQ feedback indicating a decoding status of the data packet at the first UE device and the second HARQ feedback indicating a decoding status of the data packet at the second UE device. The processor determines to stop transmission of the data packet in response to at least one of the first and second HARQ feedback being a positive acknowledgement.

In some embodiments, the first UE device comprises at least one sidelink remote receiver device and the second UE device comprises at least one sidelink relay device. In certain embodiments, the first HARQ feedback is received on a first HARQ feedback opportunity and the second HARQ feedback is received on a second HARQ feedback opportunity which occurs later in time than the first HARQ feedback opportunity.

In certain embodiments, the processor waits for a final feedback acknowledgement from the second UE device before transmitting a next data packet when the first HARQ feedback indicates unsuccessful decoding of the data packet and the second HARQ feedback indicates successful decoding of the data packet. In certain embodiments, the data packet transmitted to the second UE device has a Layer-1 destination identity and a Layer-2 destination identity of the first UE device.

In some embodiments, the first UE device comprises a first sidelink relay device and the second UE device comprises a second sidelink relay device. In certain embodiments, the processor determines a CBR of a direct link to a sidelink remote receiver device and further determines a level of required reliability for the data packet. In such embodiments, the processor transmits to the first UE device and the second UE device in response to both the CBR being below a threshold limit and the level of required reliability being below a threshold level.

In some embodiments, the second HARQ feedback is a positive-acknowledgement-only feedback sent on common resources. In some embodiments, the processor determines a level of required reliability for the data packet. In such embodiments, the processor transmits to the first UE device and the second UE device in response to the level of required reliability being above a threshold level.

In some embodiments, the processor determines a CBR of a link to the first UE device (e.g., direct link to Rx Remote UE). In such embodiments, the processor transmits to the first UE device and the second UE device in response to the CBR being above a threshold limit. In some embodiments, based on a CBR and a level of required reliability for the data packet, the processor determines a number of second UE devices to which to transmit the data packet. In some embodiments, the processor implements a PDCP entity that duplicates the data packet to a first RLC entity and a second RLC entity, the first RLC entity being associated with an interface to the first UE device and the second RLC entity being associated with an interface to the second UE device.

Disclosed herein is a first method for improved communications using relay over sidelink radio interface, according to embodiments of the disclosure. The first method may be performed by a transmitting remote UE device in a mobile communication network, such as the remote unit 105, the Tx-Remote-UE (i.e., UE1) 201, and/or the user equipment apparatus 600, described above. The first method includes transmitting a data packet via a sidelink interface, where the data packet is transmitted to a first UE device (i.e., Rx Remote UE) and a second UE device (i.e., SL Relay UE). The first method includes receiving a first HARQ feedback from the first UE device and receiving a second HARQ feedback from the second UE device. Here, the first HARQ feedback indicating a decoding status of the data packet at the first UE device and the second HARQ feedback indicating a decoding status of the data packet at the second UE device. The first method includes determining to stop transmission of the data packet in response to at least one of the first and second HARQ feedback being a positive acknowledgement.

In some embodiments, the first UE device comprises at least one sidelink remote receiver device and the second UE device comprises at least one sidelink relay device. In certain embodiments, the first HARQ feedback is received on a first HARQ feedback opportunity and the second HARQ feedback is received on a second HARQ feedback opportunity which occurs later in time than the first HARQ feedback opportunity.

In certain embodiments, the first method includes waiting for a final feedback acknowledgement from the second UE device before transmitting a next data packet when the first HARQ feedback indicates unsuccessful decoding of the data packet and the second HARQ feedback indicates successful decoding of the data packet. In certain embodiments, the data packet transmitted to the second UE device has a Layer-1 destination identity and a Layer-2 destination identity of the first UE device.

In some embodiments, the first UE device comprises a first sidelink relay device and the second UE device comprises a second sidelink relay device. In certain embodiments, the first method includes determining a CBR of a direct link to a sidelink remote receiver device and determining a level of required reliability for the data packet. In such embodiments, the first method further includes transmitting to the first UE device and the second UE device in response to both the CBR being below a threshold limit and the level of required reliability being below a threshold level.

In some embodiments, the second HARQ feedback is a positive-acknowledgement-only feedback sent on common resources. In some embodiments, the first method includes determines a level of required reliability for the data packet. In such embodiments, the first method further includes transmits to the first UE device and the second UE device in response to the level of required reliability being above a threshold level.

In some embodiments, the first method includes determining a CBR of a link to the first UE device (e.g., direct link to Rx Remote UE). In such embodiments, the first method further includes transmitting to the first UE device and the second UE device in response to the CBR being above a threshold limit. In some embodiments, based on a CBR and a level of required reliability for the data packet, the first method includes determining a number of second UE devices to which to transmit the data packet. In some embodiments, the first method includes implementing a PDCP entity that duplicates the data packet to a first RLC entity and a second RLC entity, the first RLC entity being associated with an interface to the first UE device and the second RLC entity being associated with an interface to the second UE device.

Disclosed herein is a second apparatus for improved communications using relay over sidelink radio interface, according to embodiments of the disclosure. The second apparatus may be implemented by a sidelink relay UE device in a mobile communication network, such as the remote unit 105, the SL-Relay-UE (UE2) 203, the first SL-Relay-UE (UE2a) 301, the second SL-Relay-UE (UE2b) 303, and/or the user equipment apparatus 600, described above. The second apparatus includes a processor and a transceiver that receives a data packet from a first UE device (i.e., Tx Remote UE) via a first sidelink interface and transmits a first HARQ feedback to the first UE device in response to the processor successfully decoding the data packet. The transceiver transmits the data packet to a second UE device (i.e., Rx Remote UE) via a second sidelink interface.

In some embodiments, transmitting the data packet occurs in response to receiving a negative HARQ feedback from the second UE device. In certain embodiments, the transceiver sends a final HARQ feedback to the first UE device in response to receiving a positive HARQ feedback from the second UE device for the data packet.

In certain embodiments, the received data packet has both Layer-1 and Layer-2 source identities of the first UE device and both Layer-1 and Layer-2 destination identities of the second UE device. In such embodiments, transmitting the data packet to a second UE device includes reusing the Layer-1 and Layer-2 source identities and the Layer-1 and Layer-2 destination identities of the received data packet.

In certain embodiments, the processor reuses a HARQ process identity of the first UE device, where the received data packet has a first RV value. In such embodiments, transmitting the data packet includes generating a new HARQ retransmission packet corresponding to an incremented RV value of the data packet to a next RV value.

In certain embodiments, the received data packet has both Layer-1 and Layer-2 source identities of the first UE device and both Layer-1 and Layer-2 destination identities of the second UE device. In such embodiments, transmitting the data packet to a second UE device includes using the Layer-1 and Layer-2 source identities of the apparatus and reusing the Layer-1 and Layer-2 destination identities of the received data packet.

In certain embodiments, the received data packet has a first RV value. In such embodiments, transmitting the data packet further includes incrementing the RV value and generating a HARQ retransmission packet for the data packet corresponding to a next RV value. In some embodiments, the processor adopts a Layer-1 and Layer-2 source identity of the second UE device.

Disclosed herein is a second method for improved communications using relay over sidelink radio interface, according to embodiments of the disclosure. The second method may be performed by a sidelink relay UE device in a mobile communication network, such as the remote unit 105, the SL-Relay-UE (UE2) 203, the first SL-Relay-UE (UE2a) 301, the second SL-Relay-UE (UE2b) 303, and/or the user equipment apparatus 600, described above. The second method includes receiving a data packet from a first UE device (i.e., the Tx Remote UE) via a first sidelink interface, transmitting a first Hybrid HARQ feedback to the first UE device in response to successfully decoding the data packet, and transmitting the data packet to a second UE device (i.e., Rx Remote UE) via a second sidelink interface.

In some embodiments, transmitting the data packet occurs in response to receiving a negative HARQ feedback from the second UE device. In certain embodiments, the transceiver sends a final HARQ feedback to the first UE device in response to receiving a positive HARQ feedback from the second UE device for the data packet.

In certain embodiments, the received data packet has both Layer-1 and Layer-2 source identities of the first UE device and both Layer-1 and Layer-2 destination identities of the second UE device. In such embodiments, transmitting the data packet to a second UE device includes reusing the Layer-1 and Layer-2 source identities and the Layer-1 and Layer-2 destination identities of the received data packet.

In certain embodiments, the second method includes reusing a HARQ process identity of the first UE device, where the received data packet has a first RV value. In such embodiments, transmitting the data packet includes generating a new HARQ retransmission packet corresponding to an incremented RV value of the data packet to a next RV value.

In certain embodiments, the received data packet has both Layer-1 and Layer-2 source identities of the first UE device and both Layer-1 and Layer-2 destination identities of the second UE device. In such embodiments, transmitting the data packet to a second UE device includes using the Layer-1 and Layer-2 source identities of the sidelink relay UE device and reusing the Layer-1 and Layer-2 destination identities of the received data packet.

In certain embodiments, the received data packet has a first RV value. In such embodiments, transmitting the data packet further includes incrementing the RV value and generating a HARQ retransmission packet for the data packet corresponding to a next RV value. In some embodiments, the second method includes the sidelink relay UE device adopting Layer-1 and Layer-2 source identities of the second UE device.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-20. (canceled)

21. A User Equipment (“UE”) apparatus comprising:
a memory; and
a processor coupled to the memory, the processor configured to cause the apparatus to:
transmit a data packet via a sidelink interface, wherein the data packet is transmitted to a first UE device and a second UE device;
receive a first Hybrid Automatic Repeat Request (“HARQ”) feedback from the first UE device, the first HARQ feedback indicating a decoding status of the data packet at the first UE device;
receive a second HARQ feedback from the second UE device, the second HARQ feedback indicating a decoding status of the data packet at the second UE device; and
determine to stop transmission of the data packet in response to at least one of the first and second HARQ feedback being a positive acknowledgement.

22. The apparatus of claim 21, wherein the first UE device comprises at least one sidelink remote receiver device and the second UE device comprises at least one sidelink relay device.

23. The apparatus of claim 22, wherein the first HARQ feedback is received on a first HARQ feedback opportunity and the second HARQ feedback is received on a second HARQ feedback opportunity which occurs later in time than the first HARQ feedback opportunity.

24. The apparatus of claim 22, wherein the processor is configured to cause the apparatus to wait for a final feedback acknowledgement from the second UE device before transmitting a next data packet when the first HARQ feedback indicates unsuccessful decoding of the data packet and the second HARQ feedback indicates successful decoding of the data packet.

25. The apparatus of claim 22, wherein the data packet transmitted to the second UE device has a Layer-1 destination identity and a layer 2 destination identity of the first UE device.

26. The apparatus of claim 21, wherein the first UE device comprises a first sidelink relay device and the second UE device comprises a second sidelink relay device.

27. The apparatus of claim 26, wherein the processor is configured to cause the apparatus to:
determine a channel busy ratio (“CBR”) of a direct link to a sidelink remote receiver device and further determines a level of required reliability for the data packet, and
transmit to the first UE device and the second UE device in response to both the CBR being below a threshold limit and the level of required reliability being below a threshold level.

28. The apparatus of claim 21, wherein the second HARQ feedback is a positive-acknowledgement-only feedback sent on common resources.

29. The apparatus of claim 21, wherein the processor is configured to cause the apparatus to:
determine a level of required reliability for the data packet, and
transmit to the first UE device and the second UE device in response to the level of required reliability being above a threshold level.

30. The apparatus of claim 21, wherein the processor is configured to cause the apparatus to:
determine a channel busy ratio (“CBR”) of a link to the first UE device, and
transmit to the first UE device and the second UE device in response to the CBR being above a threshold limit.

31. The apparatus of claim 21, wherein the processor is configured to cause the apparatus to determine a number of second UE devices to transmit the data packet to based on a channel busy ratio (“CBR”) and a level of required reliability for the data packet.

32. The apparatus of claim 21, wherein the processor is configured to cause the apparatus to implement a Packet Data Convergence Protocol (“PDCP”) entity that duplicates the data packet to a first Radio Link Control (“RLC”) entity and a second RLC entity, the first RLC entity being associated with an interface to the first UE device and the second RLC entity being associated with an interface to the second UE device.

33. A Sidelink Relay apparatus comprising:
a memory; and
a processor coupled to the memory, the processor configured to cause the apparatus to:
receive a data packet from a first User Equipment (“UE”) device via a first sidelink interface;
transmit a first Hybrid Automatic Repeat Request (“HARQ”) feedback to the first UE device in response to successfully decoding the data packet; and
transmit the data packet to a second UE device via a second sidelink interface.

34. The apparatus of claim 33, wherein the processor is configured to cause the apparatus to transmit the data packet in response to receiving a negative HARQ feedback from the second UE device.

35. The apparatus of claim 34, wherein the received data packet has both Layer-1 and Layer-2 source identities of the first UE device and both Layer-1 and Layer-2 destination identities of the second UE device, wherein to transmit the data packet to a second UE device, the processor is configured to cause the apparatus to reuse the Layer-1 and Layer-2 source identities and the Layer-1 and Layer-2 destination identities of the received data packet.

36. The apparatus of claim 35, wherein the processor is configured to cause the apparatus to reuse a HARQ process identity of the first UE device, wherein the received data packet has a first redundancy version (“RV”) value, and wherein to transmit the data packet, the processor is further configured to cause the apparatus to generate a new HARQ retransmission packet corresponding to an incremented RV value of the data packet to a next RV value.

37. The apparatus of claim 34, wherein the received data packet has both Layer-1 and Layer-2 source identities of the first UE device and both Layer-1 and Layer-2 destination identities of the second UE device, wherein to transmit the data packet to a second UE device, the processor is configured to cause the apparatus to use the Layer-1 and Layer-2 source identities of the apparatus and reusing the Layer-1 and Layer-2 destination identities of the received data packet.

38. The apparatus of claim 37, wherein the received data packet has a first redundancy version (“RV”) value, wherein to transmit the data packet, the processor is further configured to cause the apparatus to increment the RV value and generate a HARQ retransmission packet for the data packet corresponding to a next RV value.

39. The apparatus of claim 34, wherein the processor is configured to cause the apparatus to send a final HARQ feedback to the first UE device in response to receiving a positive HARQ feedback from the second UE device for the data packet.

40. The apparatus of claim 33, wherein the processor is configured to cause the apparatus to adopt Layer-1 and Layer-2 source identities of the second UE device.
